(19) United States
(12) Patent Application Publication
(10) Pub. No.: US 2002/0136105 A1
(43) Pub. Date: Sep. 26, 2002

(54) Method for track locking in an optical disc drive

(76) Inventor: Yi-Chung Chan, Taipei City (TW)

Correspondence Address: NAIPO(North America International Patent Office), P.O. Box 506, Merrifield, VA, 22116, US

(21) Appl. No.: 09/683,648

(22) Filed: Mar. 22, 2002

(30) Foreign Application Priority Data
Mar. 21, 2001 (TW) 090106654

(51) Int. Cl. G11B 7/00

(52) U.S. Cl. 369/44.26; 369/44.29

(57) ABSTRACT

A method for track locking in an optical disc drive. The optical disc drive includes a pick-up device for reading data from a plurality of tracks of a compact disc. The compact disc includes a plurality of adjacent track periods, each track period including an on-track period and an off-track period, and the on-track period including only one track. The optical disc drive further includes a driving device for driving the pickup device, and a location detecting device for detecting a location of the pick-up device and producing a tracking error signal. When the access device is located at the off-track period, a corrected tracking error signal is formed by taking a reference value as a standard to convert the tracking error signa

### BACKGROUND OF INVENTION

1. Field of the Invention

The present invention relates to a method for track locking in an optical disc drive, and more specifically, to a method utilizing a tracking error signal within an off-track period as a control method for track locking.

2. Description of the Prior Art

In a designing a control chip in a compact disc/digital versatile disc (CD/DVD) drive, a track locking of an optical pick-up head (PUH) is one of the most important control actions in CD/DVD drives.

Generally, a close-loop control is used to perform the track locking of the CD/DVD drive. The close-loop control utilizes a location sensor to detect the track location of the optical pick-up head, with the obtained location information being transmitted to a controller in order to achieve the track locking which controls the pick-up head to a proper location.

Please refer to FIG. 1. FIG. 1 is a diagram of a prior optical sensor for detecting a track location of an optical pick-up head. As FIG. 1 shows, the prior optical pick-up head emits a main-beam 12 and two sub-beams 16, 18 onto a compact disc 10 for reading data in a plurality of tracks 14 of the compact disc 10. The optical sensor produces a tracking error signal 20 from a difference of reflected light intensity between the two sub-beams 16, 18. The tracking error signal 20 is used to obtain the corresponding track location of the optical pick-up head. When the optical pick-up head aims at the track 14, the two sub-beams are located beside the track 14. At this time, the difference of reflected light intensity between the two sub-beams 16, 18 is zero, meaning the tracking error signal 20 being zero, and the pick-up head is aiming at the track 14.

Nevertheless, the tracking error signal 20 produced in this structure being a sine wave, one half of a cycle of the tracking error signal 20 can not show an actual error between the optical pick-up head and the tracks. This is a congenital limitation of this type of optical pick-up head. As FIG. 1 shows, when the main-beam 12 emits on an on-track period 21, the tracking error signal can show the actual error between the optical pick-up head and the tracks. However, when the main-beam 12 emits on an off-track period 22, a change of the tracking error signal can not show that the main-beam 12 is far away from the tracks 14. Therefore, if the tracking error signal 20 in the off-track period 22 is transmitted to the controller, the controller obtains a wrong location information that causes a control system to go into a divergence state, and can not control the optical pick-up head exactly. To overcome this problem, a prior art utilizes a peak-hold method.

Please refer to FIG. 2. FIG. 2 is a diagram of a prior peak-hold controlling method.

The prior peak-hold controlling method is capable of correcting the above tracking error signal 20 by producing a corrected tracking error signal 24 to input into the controller to prevent the diversion state. As FIG. 2 shows, if the optical pick-up head is located at the off-track period 22, the peak-hold control method is capable of holding a peak value 22B of the tracking error signal 20 in order to produce the corrected tracking error signal 24. Therefore, the controller of the CD/DVD drive is capable of driving the optical pick-up head to lock to a target track according to the corrected tracking error signal 24.

Still, the peak-hold control method has some defects. In the actual application, although the above peak-hold control method can achieve a certain effect on a condition of low rotational speed operation or a low disc run-out, the method still can not achieve a satisfying result, for example in a high rotational speed operation (exceeding 5000 rpm), or a high disc run-out (exceeding 70 μm). Generally, the number of tracks being slided is higher in the peak-hold control method, and it takes more time on track locking.

Furthermore, in another prior track locking method, a brake pulse is used to solve the problem of the congenital limitation. In this control structure, when the optical pick-up head is located at the off-track period 22, a driver can directly output a brake pulse to drive the pick-up head regardless of the magnitude of the tracking error signal, thereby reducing speed of the pick-up head and pushing the pick-up head to the target track. But, this control method cannot avoid producing an overshoot or an undershoot state in lower track-crossing speed. That is, the pick-up head can vibrate back and forth at the target track and can not converge. The number of tracks being slided is reduced, but time taking on track locking can not be reduced.

### SUMMARY OF INVENTION

It is therefore a primary objective of the invention to provide a method for track locking in a compact disc/digital versatile disc (CD/DVD) drive and, more specifically, to utilize a corrected tracking error signal within an off-track period for track locking.

The present invention discloses a method for track locking in an optical disc drive. The optical disc drive comprises a pick-up device for reading data from a plurality of tracks of a compact disc. The compact disc comprises a plurality of adjacent track periods, each track period including an on-track period and an off-track period, and the on-track period including only one track. The optical disc drive further comprises a driving device for driving the pick-up device, and a location detecting device for detecting a location of the pick-up device and producing a tracking error signal. When the access device is located at the off-track period, a corrected tracking error signal is formed by taking a reference value as a standard to convert the tracking error signal.

It is an advantage of the present invention that the present method for track locking in an optical disc drive provides an effective brake force to reduce speed of the pick-up head when the pick-up head has a high track-cross speed. When the pick-up head has a low track-cross speed, the system is normally converged by an exact error signal, preventing the overshoot or the undershoot state. The experimental result also shows that the present invention can reduce the number of the tracks slided, shorten the track locking time, and enhance the track locking efficiency.

These and other objectives and advantages of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of a prior optical sensor for detecting a corresponding track location of an optical pick-up head.

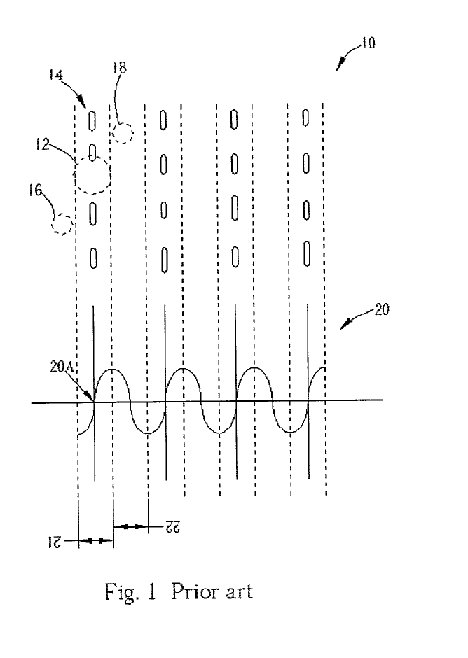

FIG. 2 is a diagram of a prior peak-hold controlling method.

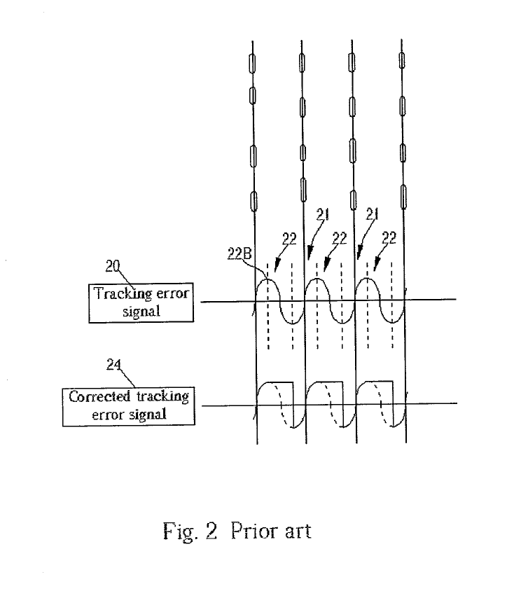

FIG. 3 is a diagram of a control system of an optical disc drive according to one embodiment of the present invention.

FIG. 4 is a diagram of signals depicted in FIG. 3.

FIG. 5 is a flow chart of a track locking method according to the present invention.

FIG. 6A is a diagram of experiment results for a prior peak-hold control method.

FIG. 6B is a diagram of experiment results for the present invention.

### DETAILED DESCRIPTION

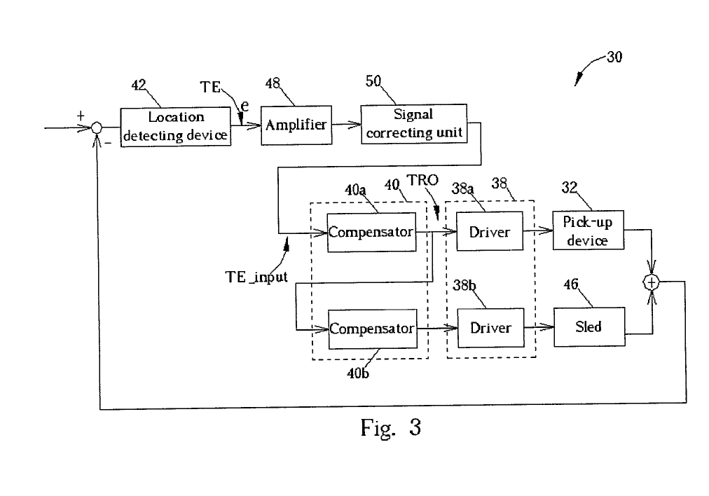

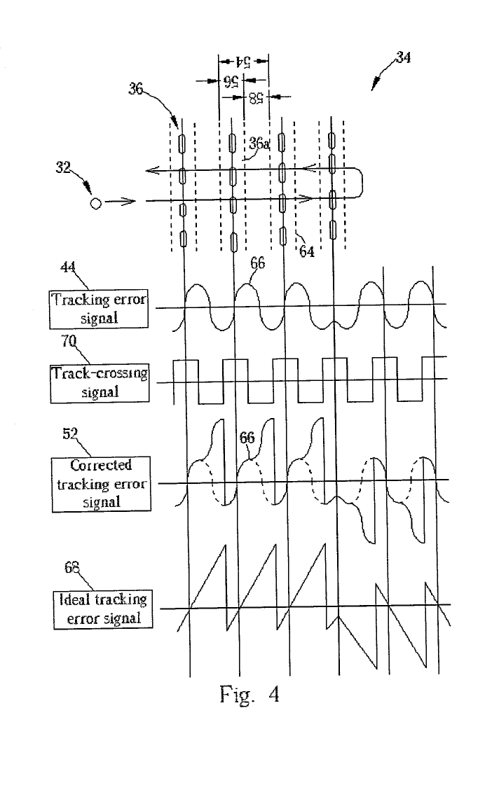

Please refer to FIG. 3. FIG. 3 is a diagram of a control system of an optical disc drive 30 according to one embodiment of the present invention. The optical disc drive 30 comprises a pick-up device (such as an optical pick-up head) 32 disposed on a sled 46 for reading data from a plurality of tracks 36 (FIG. 4) of a compact disc 34, a driving device 38 for driving the access device 32 to move between the plurality of tracks 36, a location detecting device (such as an optical sensor) for detecting a location of the pick-up device 32 and producing a tracking error signal TE, and a control device 40 for controlling the driving device 38. As FIG. 3 shows, the driving device 38 comprises two drivers 38a, 38b for relatively moving the pick-up device 32 on the sled, and respectively moving the sled 46 to the optical disc drive 30. The control device 40 comprises two compensators 40a, 40b for controlling the drivers 38a, 38b, respectively. The compensators 38a, 38b are, for example, prior PID controllers that can produce proper control signals according to corresponding error signals.

As FIG. 3 shows, the location device 42 produces the above tracking error signal TE from a corresponding movement of the pick-up device 32 to the track 36. The corresponding movement is produced by a combination of a disc run-out and a movement of the pick-up device 32. The tracking error signal TE, through an amplifying process of an amplifier 48, is converted into a corrected tracking error signal TE_input by a signal correcting unit 50. The control device 40 controls the driving device 38 according to the corrected tracking error signal TE_input in order to lock the pick-up device 32 to an target.

Please refer to FIG. 4. FIG. 4 is a diagram of signals depicted in FIG. 3. As FIG. 4 shows, the compact disc 34 comprises a plurality of adjacent track periods 54, each track period 54 comprising an on-track period 56 and an off-track period 58. The tracking error signal TE produced by the location detecting device 42 is a sine wave with the track period 54 as a cycle. On the left side of FIG. 4 is a waveform of the tracking error signal TE when the pick-up device 32 moves outward along the compact disc. On the right side of FIG. 4 is a waveform of the tracking error signal TE when the pick-up device 32 moves inward along the compact disc.

As FIG. 4 shows, when the pick-up device 32 is located at the on-track period 56, the location detecting device 42 produces the tracking error signal TE with a negative half-cycle feedback. When the pick-up device 32 is located at the off-track period 58, the location detecting device 42 produces the tracking error signal TE with a positive half-cycle feedback. When the pick-up device 32 is located at a common border 64 between the on-track period 56 and the off-track period 58, the tracking error signal TE has a reference value 66.

A main conception of the present invention is to utilize the tracking error signal TE with a positive half-cycle feedback comprising location error data within the off-track period 58 for producing the above correcting tracking error signal TE_input, in order for the control device to control exactly the pick-up device 32 to lock to the target track. When the pick-up device 32 is located at the target track 36a, being within the on-track period 56, the corrected tracking error signal TE_input is the same as an original tracking error signal TE. When the pick-up device 32 is located at the target track 36a, being within the off-track period 56 of the track period 58, the corrected tracking error signal TE_input is a mirror signal of the tracking error signal TE by taking the reference value 66 as a standard to convert the tracking error signal TE. When the pick-up device 32 is near to the target track 36a, the corrected tracking error signal TE_input is smaller. When the pick-up device 32 is far from the target track 36a, the corrected tracking error signal TE_input is larger. The corrected tracking error signal TE_input is approximately proportional to a distance between the pick-up device 32 and the target track 36a, which tends to a linear ideal tracking error signal 68. As such, the corrected tracking error signal TE_input can exactly show the distance between the pick-up device 32 and the target track 36a, in order for the control device 40 to control exactly the pick-up device 32 to lock to the target track 36a.

In practical applications, the above tracking control method and the correcting method of the tracking error signal is established in a control chip of an optical disc drive. The control chip can differentiate a location of the pick-up device 32, according to a track cross signal 70 (such as Radio Frequency Zero Cross, RFZC signal). As FIG. 4 shows, when the RFZC signal 70 is in a high level, the corrected tracking error signal TE_input is determined to be the same as the original tracking error signal TE. When the RFZC signal 70 is in a low level, the corrected tracking error signal TE_input is a mirror signal of the tracking error signal TE.

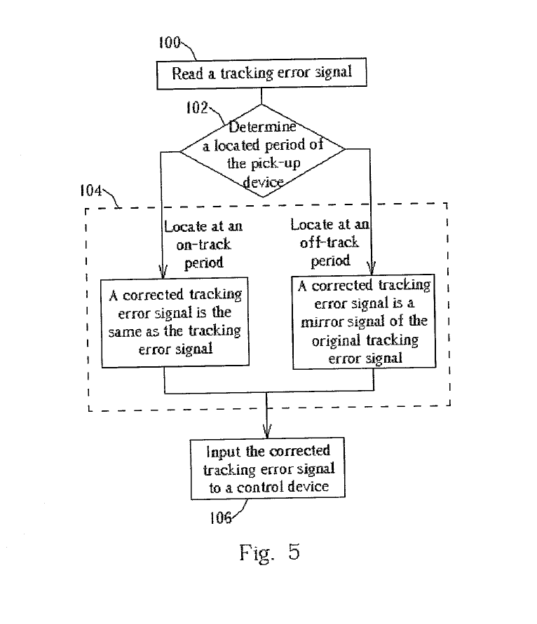

Please refer to FIG. 5. FIG. 5 is a flow chart of a track locking method according to the present invention. The track locking method comprises: Step 100: reading the tracking error signal TE; Step 102: reading the track cross signal to differentiate a location of the pick-up device 32 (at the on-track period or the off-track period); Step 104: producing the corrected tracking error signal TE_input, according to the tracking error signal TE:1) when the access device 32 is located at the ending track 36a of the on-track period 56, the corrected tracking error signal TE_input is the same as the tracking error signal TE:2) when the pick-up device 32 is located at the target track 36a of the off-track period 58, the corrected tracking error signal TE_input is a mirror signal of the track cross signal by taking the tracking error signal TE as a standard to convert the tracking error signal TE; and Step 106: inputting the corrected tracking error signal TE_input into the control device 40 for controlling the driving device 38 in order to lock to the track by the pick-up device 32.

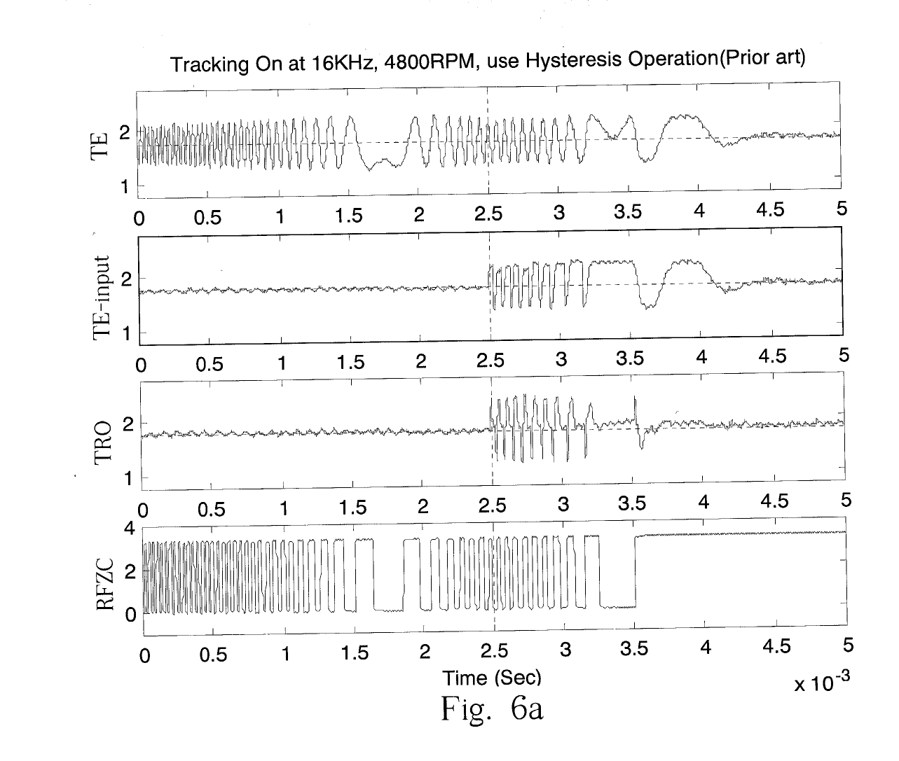

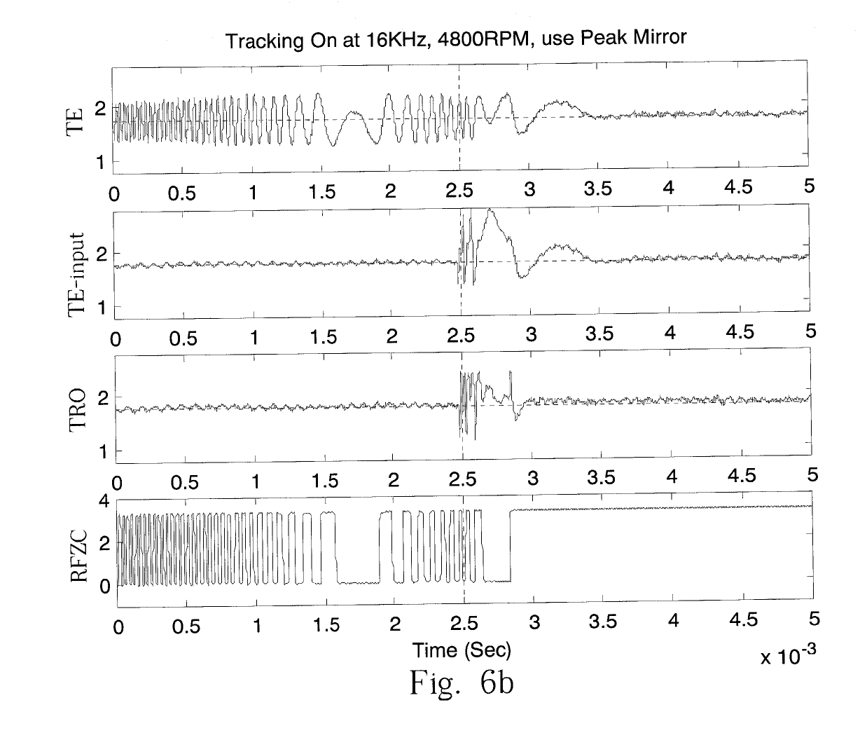

Please refer to FIG. 6A and FIG. 6B. FIG. 6A is a diagram of experimental results for a prior peak-hold control method. FIG. 6B is a diagram of experimental results for the track locking method according to the present invention. As shown in FIG. 6A and FIG. 6B, TE is the tracking error signal TE, TE_input is the corrected tracking error signal TE_input transmitted to the control device 40, TRO is a control command signal transmitted from the compensator 40a to the driver 38a, and RFZC is the Radio Frequency Zero Cross signal (the track cross signal 70). As shown in FIG. 6A, in a case of a rotational speed of 4800 rpm and a track crossing speed of 16 kHz, the prior peak-hold method produces a tracking command to lock a track, with nine tracks slided and a track locking time of 20 ms. As shown in FIG. 6B, for the same conditions as above, the number of tracks slided is 2 and the track locking time is 1.0 ms. The track locking method not only decrease the number of tracks slided, but also shortens the track locking time, meaning the track is locked rapidly.

In contrast to the prior art, the track locking method of this invention utilizes the tracking error signal TE of the positive half-cycle feedback, that comprises distance data between the pick-up device 32 and the target track 36a, in order to produce the corresponding corrected tracking error signal TE_input. Furthermore, when the pickup head has a high track-crossing speed, the present invention produces an effective brake force, and when the pick-up head has a low track-crossing speed, the system is normally converged by an exact error signal thereby preventing the overshoot or the undershoot state. The experimental result also shows that the present invention can reduce the number of the tracks slided, shorten the track locking time, and enhance the track locking efficiency.

The above disclosure is not intended as limiting. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for track locking in an optical disc drive, the optical disc drive comprising an pick-up device for reading data from a plurality of tracks of an optical disc, the optical disc comprising a plurality of adjacent track periods, each track period comprising an on-track period and an off-track period, the on-track period comprising only one track, the optical disc drive further comprising a driving device for driving the pick-up device, and a location detecting device for detecting a location of the pick-up device and producing a tracking error signal, the method comprising:
producing a corrected tracking error signal, according to the tracking error signal, when the pick-up device is located at a target track related to the off-track period, the corrected tracking error signal being a mirror signal of the tracking error signal; and
controlling the driving device to enable the pick-up device to lock at the target track, according to the corrected tracking error signal;

2. The track locking method of claim 1, wherein a reference value of the tracking error signal is obtained when the pick-up device is located at a common border between the on-track period and the off-track period, and the mirror signal is obtained by taking the reference signal as a reference to convert the tracking error signal.

3. The track locking method of claim 1, wherein in the step of producing the corrected tracking error signal, when the pick-up device is located at the off-track period related to the target track, the corrected tracking error signal is approximately proportional to a distance between the pick-up device and the target track.

4. The track locking method of claim 3, wherein the step of producing the corrected tracking error signal further comprises:
when the access device is located at the on-track period of the target track, using the tracking error signal as the corrected tracking error signal.

5. The track locking method of claim 1 further comprising:
differentiating a location of the pick-up device, according to a track cross signal.

6. The track locking method of claim 5, wherein the track cross signal is a Radio Frequency Zero Cross (RFZC) signal.

7. An optical disk drive with a pick-up device for reading data from a plurality of tracks of a compact disc, the compact disc comprising a plurality of adjacent track periods, each track period comprising an on-track period and an off-track period, the on-track period having only one track, the optical disc drive comprising:
a driving device for driving the pick-up device;
a location detecting device electrically connected to the pick-up device for detecting a location of the pick-up device and producing a tracking error signal when the pick-up device is located at a common border between the on-track period and the off-track period, the tracking error signal having a reference value;
a signal correcting unit electrically connected to the location detecting device for producing a corrected tracking error signal according to the tracking error signal; and
a control device electrically connected to the signal correcting unit for controlling the driving device according to the corrected tracking error signal;
wherein when the pick-up device is located within the off-track period related to a target track, the corrected tracking error signal is a mirror signal of the tracking error signal.

8. The optical disc drive of claim 7, wherein when the pick-up device is located within the off-track period related to the target track, the corrected tracking error signal is approximately proportional to a distance between the pick-up device and the target track.

9. The optical disc drive of claim 7, wherein when the pick-up device is located at the on-track period related to the target track, the corrected tracking error signal is the same as the tracking error signal.

10. The optical disc drive of claim 7, wherein the signal correcting unit differentiates the location of the pick-up device according to a track cross signal.

11. The optical disc drive of claim 10, wherein the track cross signal is a Radio Frequency Zero Cross (RFZC) signal.
